(19) United States
(12) Patent Application Publication
(10) Pub. No.: US 2006/0247903 A1
(43) Pub. Date: Nov. 2, 2006

(54) Automated system for identifying optimal re-drilling trajectories

(76) Inventors: Gary Schottle, Sugar Land, TX (US); Jerry Codling, Stafford (GB)

Correspondence Address: NEEDLE & ROSENBERG, P.C., SUITE 1000, 999 PEACHTREE STREET, ATLANTA, GA, 30309-3915, US

(21) Appl. No.: 11/119,371

(22) Filed: Apr. 29, 2005

(51) Int. Cl. G06G 7/48

(52) U.S. Cl. 703/10

(57) ABSTRACT

An automated system for identifying an optimal re-drilling trajectory to reach a target using a previously drilled well is described. It creates substantial advantages in the time and cost saving that result from increasing drilling efficiency. In one embodiment, the invention is a system for identifying an optimal well path to reach a target using a previously drilled well. The system includes an input device for receiving information from a user, and a server receives information from the input device. An automated re-drilling software program is provided for identifying an optimal well path to reach a target using a previously drilled well and performs several steps. A plurality of well paths for reaching the target is identified. The software automatically identifies a subset of the plurality of well paths that satisfy selected criteria, and at least one of the subset of well paths is designated as the optimal well path.

### FIELD OF THE INVENTION

The present invention generally relates to drilling operations in the oil and gas industry. More specifically, the invention relates to an automated system for identifying an optimal re-drilling trajectory using a previously drilled well that reaches a new target.

### DESCRIPTION OF THE RELATED ART

With the growing demand for natural resources and correspondingly limited supply, there has been a departure from exploratory drilling towards more focused drilling that increases production efficiency. For example, the primary natural resources that have great economic impact are oil and gas. Despite this vital role and quest for production efficiency, exploratory drilling remains the dominant production ideology in the United States. Essentially, exploratory drilling embraces a “dig and see” approach. That is, a minimal amount of planning is done initially, while focusing on post drilling outcomes. Because of the limited initial planning, exploratory drilling is often inefficient and causes considerable time and money expense.

As an alternative to exploratory drilling that satisfies the quest for production efficiency, some conventional methods have used re-drilling. Re-drilling generally involves attempting to reach a new target using a well that was previously drilled for another target. In essence, a secondary well (i.e., an offset) is drilled from the previous well that reaches the new target. Re-drilling increases production efficiency by not utilizing resources drilling a new well bore. Consequently, the cost of reaching the new target is primarily the cost of forming the offset from the previously drilled well to the new target.

Even though re-drilling avoids exploratory drilling and increases production efficiency, the inherent inefficiency of conventional re-drilling methods still greatly limits production efficiency. For example, conventional re-drilling methods are time intensive because they utilize an exploratory approach. In other words, an operator often spends five business days both identifying relevant re-drilling parameters and finding a trajectory that meets every parameter. Normally, this trajectory is found only after several failed attempts. Even when that single trajectory is found, there is no guarantee that it is the best trajectory. Given the considerable time, which often translates into a monetary cost, conventional re-drilling methods provide only a limited increase in production efficiency. Consequently, there remains an unmet need.

### SUMMARY

The invention is an automated method for identifying an optimal well path to reach a target using a previously drilled well. The method includes identifying a plurality of well paths for reaching the target. A subset of the plurality of well paths that satisfy selected criteria are identified, and at least one of the subset of well paths is designated as the optimal well path.

In another embodiment, the invention is a computer readable medium encoded for identifying an optimal trajectory to reach a target using a previously drilled well. The medium encodes a step for identifying a plurality of well paths for reaching the target. A subset of the plurality of well paths that satisfy selected criteria are automatically identified, and at least one of the subset of well paths is designated as the optimal well path.

### BRIEF DESCRIPTION OF THE DRAWINGS

FIG. 1A is a block diagram of a system for identifying an optimal re-drilling trajectory according to the present invention.

FIG. 1B is a flowchart illustrating the re-drilling processes in the re-drilling algorithm of the re-drilling software of FIG. 1A.

FIG. 1C is a snapshot view illustrating constraint parameters that can be modified.

FIG. 2 is a flowchart highlighting of the optimization subroutine described in FIG. 1B.

FIG. 3 is a snapshot view of a status window for a graphical user interface that incorporates the automated system of FIG. 1A.

FIG. 4 is a snapshot view of a plan editor window of the graphical user interface of FIG. 3.

FIG. 5 is a snapshot view of an offset design selection window of the graphical user interface of FIG. 3.

FIGS. 6-9 are snapshot views of a plan optimizer window for the graphical user interface of FIG. 3 illustrating various parameters than may be adjusted from this window.

FIG. 10 is a pop-up window for the graphical user interface of FIG. 3 illustrating the completion percentage for the optimization subroutine described with reference to FIG. 2.

FIGS. 11-13C are snapshot views of the plan optimizer window described with reference to FIGS. 6-9 after the optimization subroutine is complete.

FIGS. 14A-14B are pop-up windows illustrating querying of a user described with reference to FIG. 1B.

FIGS. 15A-15B are snapshot views of the status windows described with reference to FIG. 3 illustrating the change in the window after the optimization subroutine is run.

While the invention is susceptible to various modifications and alternative forms, specific embodiments have been shown by way of example in the drawings and subsequently are described in detail. It should be understood; however, that the description herein of specific embodiments is not intended to limit the invention to the particular forms disclosed. In contrast, the intention is to cover all modifications, equivalents, and alternatives falling within the spirit and scope of the invention as defined by the appended claims.

### DETAILED DESCRIPTION OF EMBODIMENTS

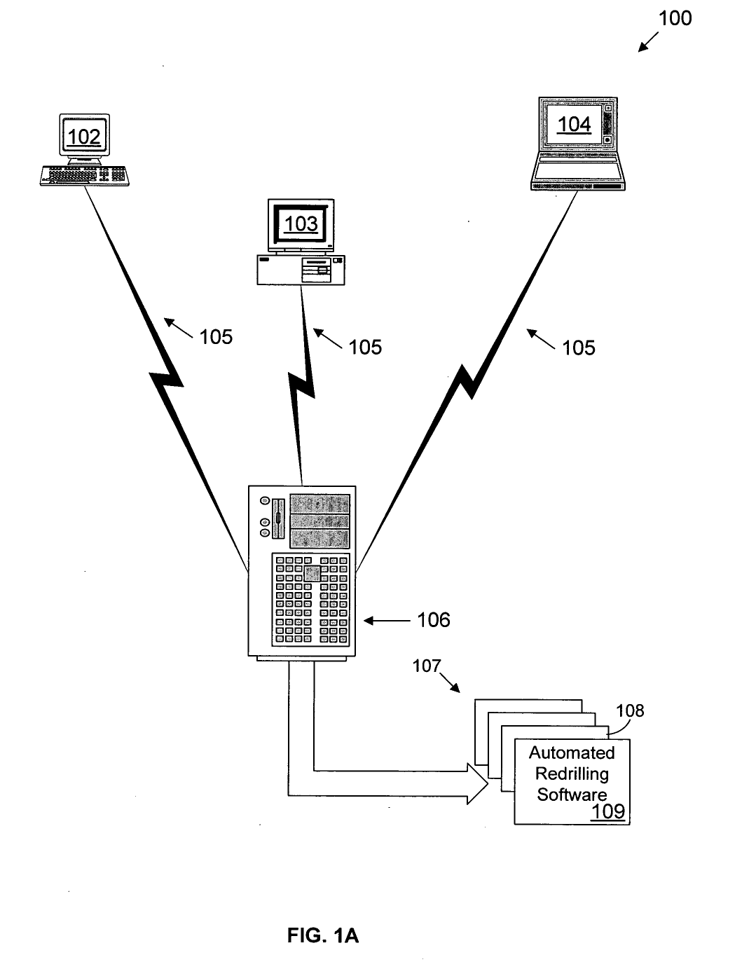

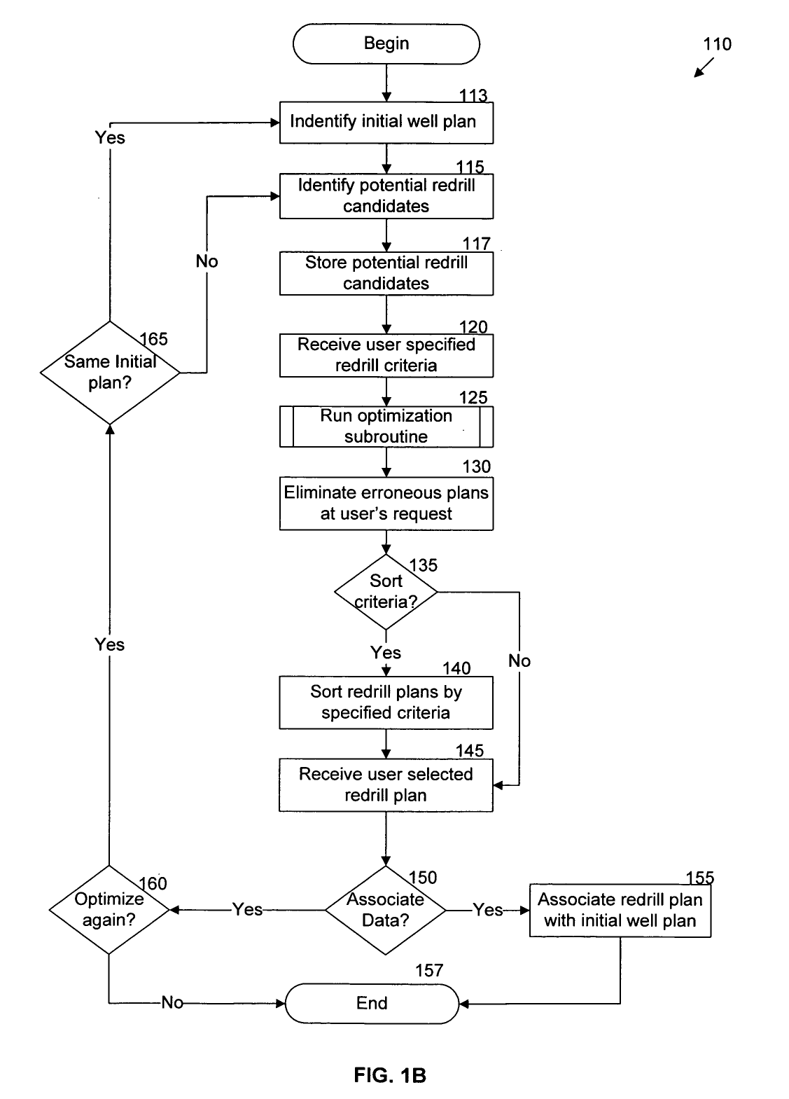

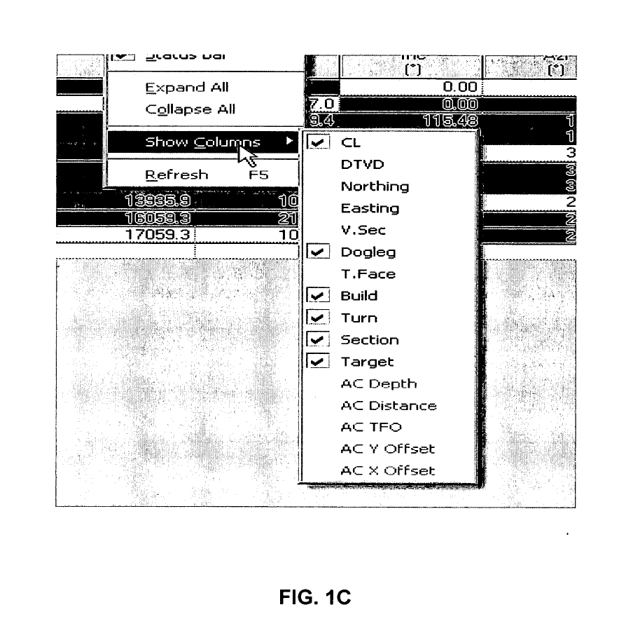

Turning now to the figures, FIG. 1A is a system 100 for identifying an optimal re-drilling trajectory according to the present invention. The system 100 includes numerous input devices, which may be any kind of conventional input device, such as a work station 102, personal computer 103, or laptop 104. With these input devices, a user (not shown) may enter various types of information as more dearly described below.

A server 106 receives information from the input devices 102-104 via the communication media 105. This communication may be any type of conventional communication media, such as a traditional network, wireless network, or some other suitable network. To process the information received via the communication media 105, the server 106 includes a host of software programs 107, which may operate on the system 100. However, one skilled in the art will appreciate that the software 107 may simultaneously determine optimal re-drilling trajectories for each of the input devices.

The software program 107 may include any type of conventional software, such as an operating system, application software, and re-drilling software 109. The re-drilling software 109 may be stored on the server 106 after installation. Alternatively, the re-drilling software 109 may be installed on a removable drive as well and run from that location via firewire or USB). Before installation, the re-drilling software 109 may be stored on a computer-readable medium, such as a compact disc. The re-drilling software 109 runs the processes associated with identifying an optimal re-drilling trajectory, which is described in greater detail with reference to the subsequent figures.

In the context of this document, a “computer-readable medium” can be any means that can contain, store, communicate, propagate, or transport the program for use by or in connection with the instruction execution system, apparatus, or device. The computer readable medium can be, for example, but, not limited to, an electronic, magnetic, optical, electromagnetic, infrared, or semiconductor system, apparatus, device, or propagation medium. More specific examples (a non-exhaustive list) of the computer-readable medium can include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium can even become paper or another suitable medium upon which the program is printed. The program can be electronically captured, via for instance optical scanning of the paper or other medium, then compiled, interpreted or otherwise processed in a suitable manner if necessary, and then stored in a computer memory.

Turning now to FIG. 1B, this figure is a flow chart highlighting the re-drilling algorithm 110 that controls the automated re-drilling software 109 identified in FIG. 1A. One skilled in the art of drilling operations will appreciate that the re-drilling algorithm 110 may be an integral part of various types of commercial drilling software, such as Compass® manufactured by Landmark Graphics, Director manufactured by Paradigm, Winserve Manufactured by Winsurv.

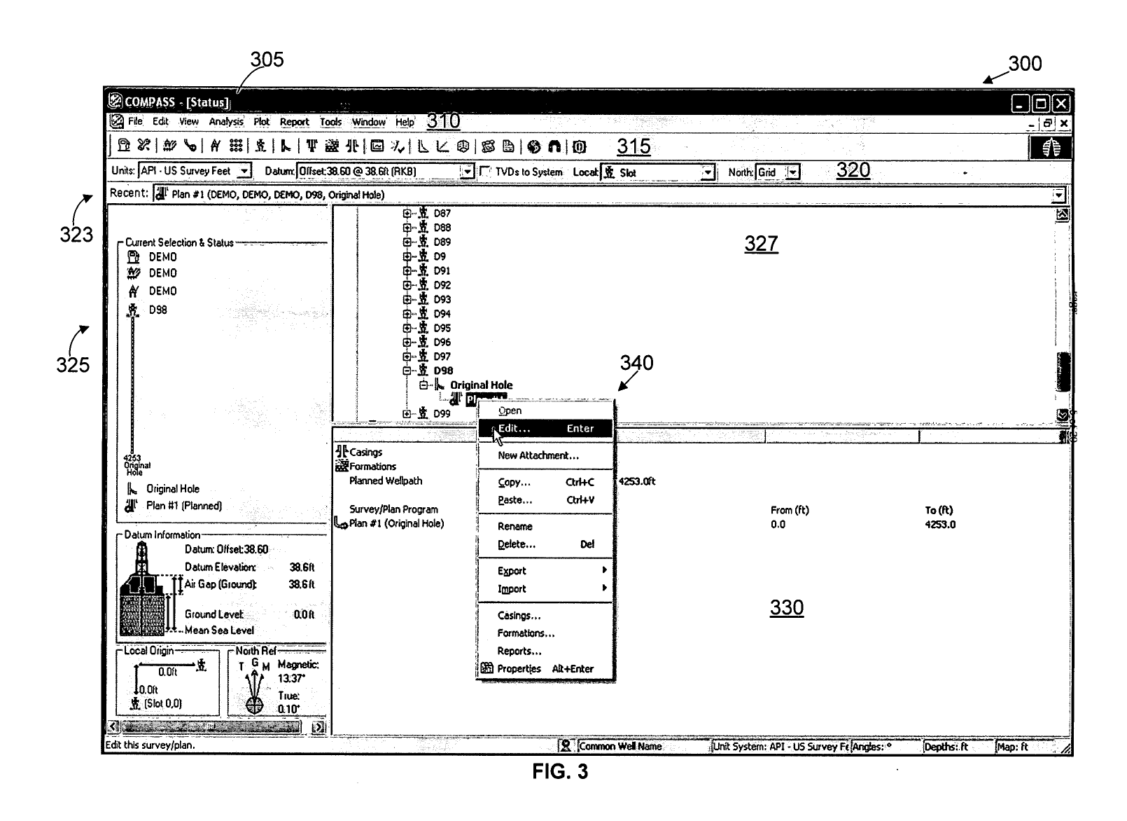

The re-drilling algorithm 110 begins at step 113 by identifying an initial well plan. A well plan is a preliminary trajectory, or well path, for reaching a selected target. Step 113 may generally involve importing a previously generated well plan from an external piece of third-party software, such as Paradigm. When third-party software is not used, this step may be omitted. Alternatively, another algorithm (not shown) within the re-drilling software may generate the initial well plan identified in this step. By completing this step, the re-drilling algorithm 110 may access all the data associated with this well plan and make this data available to a user with a graphical user interface, which is described with reference to FIG. 3.

Turning now to FIG. 3, this figure is a snapshot view of a status window for an exemplary graphical user interface that incorporates the automated system 100. This figure illustrates a graphical user interface (“GUI”) 300 for the Compass® drilling software. The GUI 300 includes the following tool bars: title bar 305, menu bar 310, toolbar 315, active viewing toolbar 320, and recent bar 323. The toolbars shown may be any kind of conventional toolbar. However, data bar 320 is subsequently described.

In addition to the title bars, the GUI 300 may include numerous windows of varying types. For example, this GUI has a current selection window 325, data hierarchy window 327, and a dynamic status window 330. The contents of this status window may vary based on a user's actions. Together windows 325-327 create the status window for GUI 300. One skilled in the art will appreciate that numerous embodiments may result from altering the number and types of bars and windows within the GUI 300.

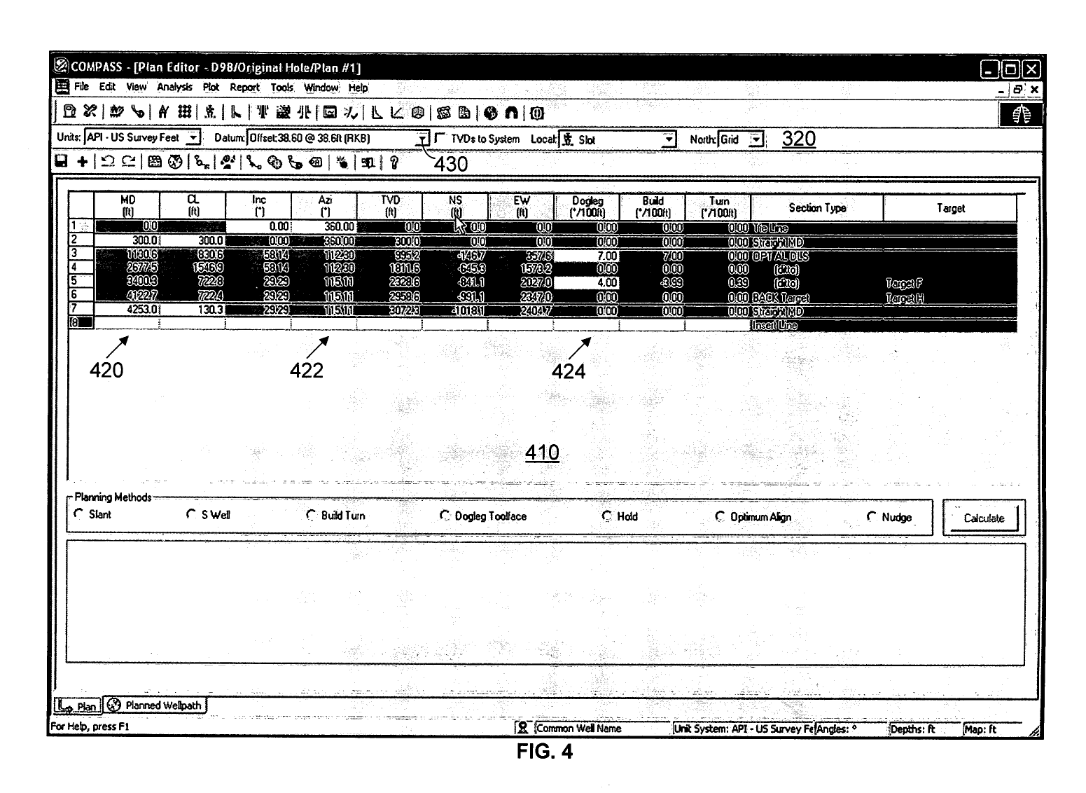

Once the re-drilling algorithm 110 identifies the initial well plan in step 113, this plan is now available for altering by a user and is shown in the window 327 as “Plan #1.” This well plan corresponds to the original hole of well plan D98. A user may access a pop-up window 340 by highlighting “Plan#1” and tapping a right button on a mouse, for example. By selecting “Edit,” a user may access all the data in the initial well plan (i.e., Plan #1). Selecting this function may open the plan editor window 410 described with reference to FIG. 4.

FIG. 4 is a snapshot view of a plan editor window 400 for the GUI 300. This window illustrates the various data types associated with the initial well plan. Using this window, a user may alter the maximum depth (see column 420), Azimuth (see column 422), or dogleg (see column 424). Other data types include the course length (distance between 2 consecutive points (labeled CL), inclination of the hole angle (labeled Inc), true vertical depth (labeled TVD), azimuth angle (labeled AZI), North/South distance (labeled NS), East/West distance (labeled EW), dogleg, rate as which one is building (labeled BUILD), and how fast it is turning (labeled TURN) section type, and target. Because the plan can be comprised of numerous section types, associated with parameters used in constructing the path, this varies the constraints that can be modified in window 400. In addition, individual columns may either be shown or hidden as illustrated in FIG. 1C.

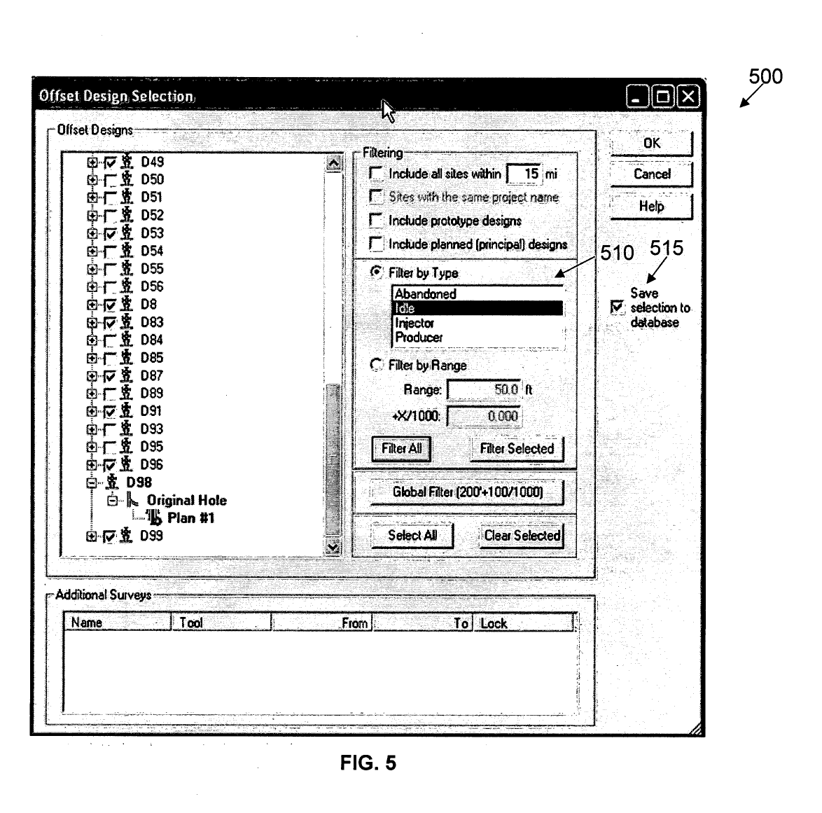

Returning to FIG. 1B, step 113 is followed by step 115. In this step, the re-drilling algorithm 110 identifies potential re-drill candidates. In an alternative embodiment, this may include awaiting input from a user for modifying some of the data mentioned with reference to FIG. 4. For example, a user may access the datum pull-down menu using the down arrow 430. Offset designs are selected in the offset design dialog selection box 500 (see FIG. 5). This dialog becomes accessible after selecting the offset design icon on the toolbar or through the analysis menu option. A user may designate certain offset designs by placing checkmarks next to them. As previously mentioned, offset wells are previously drilled wells that serve as a starting point for adding a well path to reach an additional target during a re-drill. In FIG. 5, well bores D49, D53, D8, D83, D87, D91, D96, and D99 are designated as desired offset wells.

The software 109 includes an offset filter-by-type function that facilitates easy identification of potential offset wells. To access this function, a user may select the type of filter in filter-by-type selection box 510 (see FIG. 5). For example, a user may filter by abandoned wells, idle wells, injector wells, or producer wells. This avoids re-drilling wells that are currently producing large amounts of oil or gas. Moreover, this filtering also facilitates identifying wells that are actual wells instead of well plans that have never been drilled. After filtering the wells, the user may then select the particular offset designs and designate them as potential re-drill candidates using the checkmark system described above.

In an alternative embodiment, the step 115 may be a subroutine that includes several steps. For example, the steps may be querying a user, importing the user's response to the query, and a making more information available to the user based on the user's response. In one implementation, the algorithm 110 may request that the user select interested offset designs and use those as the potential re-drill candidates.

Returning to FIG. 1B, step 115 is followed by step 117. In this step, the re-drilling algorithm 110 stores all of the potential re-drill candidates. This storing may be performed by any number of conventional storing methods, such as storing the potential re-drill candidates in a database. To facilitate storing, the offset design selection box 500 includes a save selection box 515. When a user selects this box, the re-drilling algorithm 110 may complete step 117 and store the potential re-drill candidates to a database.

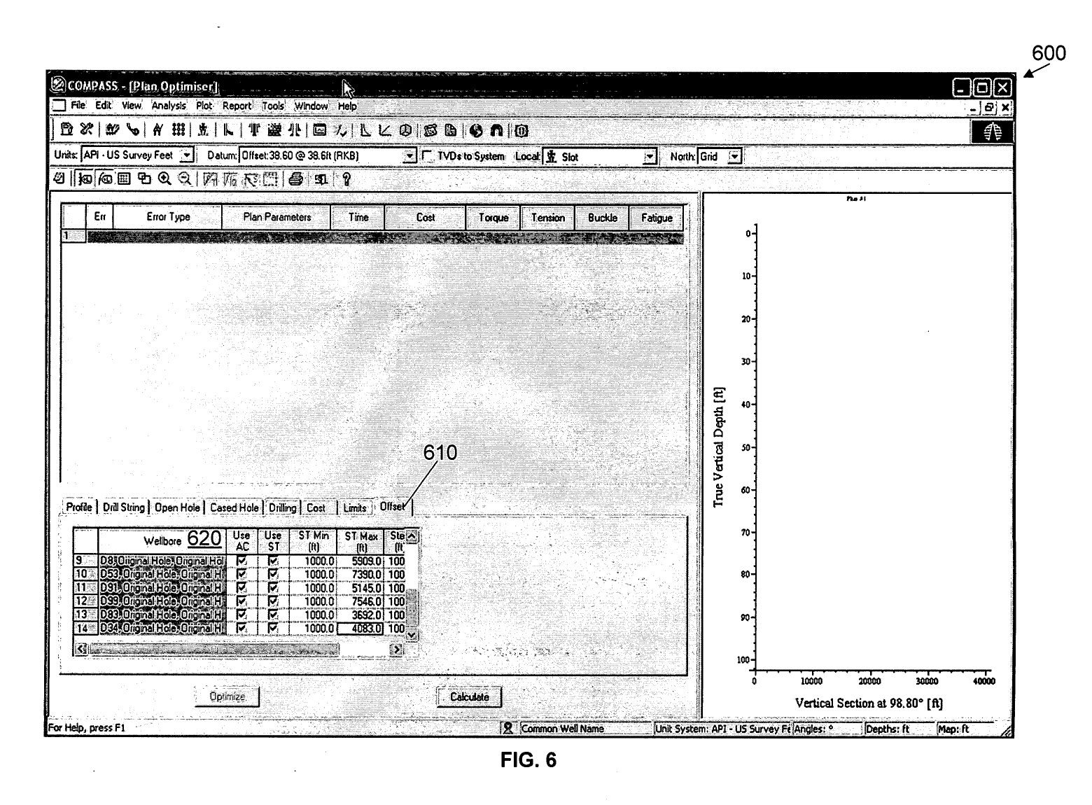

By completing step 117, the algorithm 110 makes data relating to the stored potential re-drill candidates available in a plan optimizer window 600 (see FIG. 6). More specifically, this data becomes available under the offset tab 610. Therefore, well bores D8, D53, D91, D99, D83, and D34, which are shown in well bore column 620, appear in the offset-design selection box 500 (see FIG. 5) with checkmarks. One skilled in the art will appreciate that the well bore D34 is in the upper portion of the offset-design, selection box 500 that is not shown in the view shown in FIG. 5.

Step 117 is followed by step 120. In step 120, the re-drilling algorithm 110 receives user-specified re-drill criteria. These criteria represent constraints that the optimal re-drill trajectory should satisfy. Although shown as a single step, step 120 may be a subroutine that involves a series of steps, such as querying the user, importing the user's response, and making more information available to the user based on the user's response.

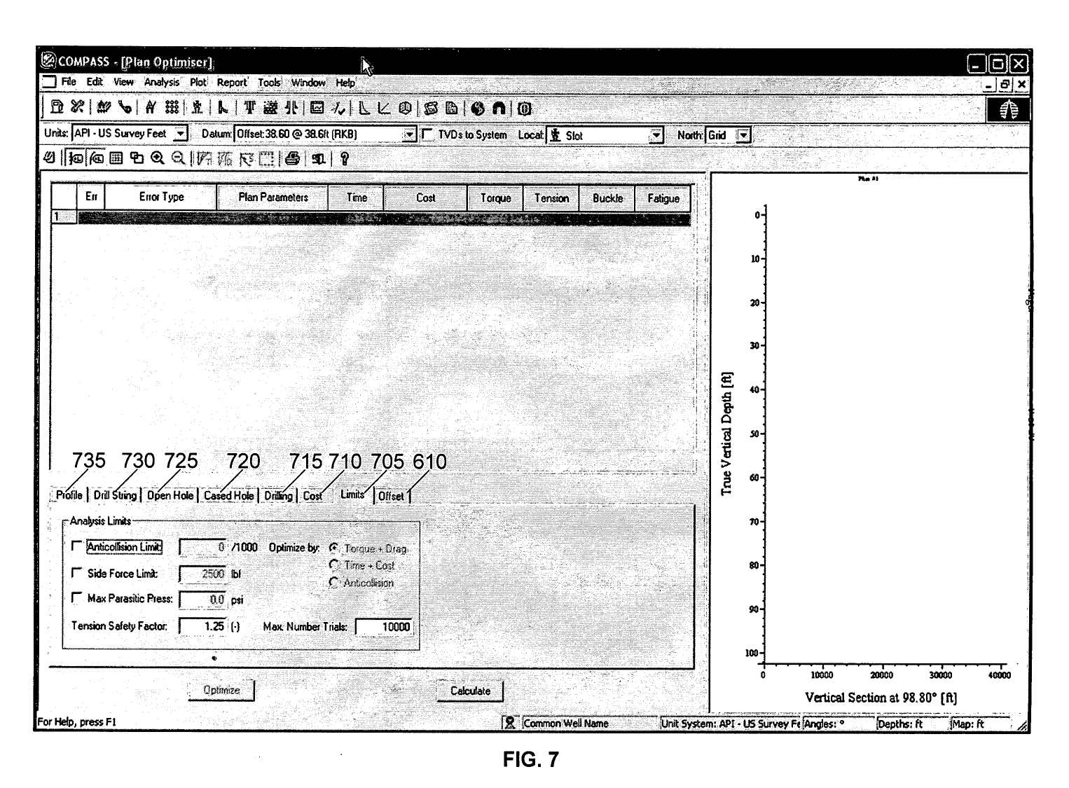

To specify the re-drill criteria, a user may utilize the tabs 705-735 illustrated in FIG. 7. Using tab 705 a user may specify various limits, such as the anti-collision limit, side-force limit, maximum parasitic press, tension safety factor, the maximum number of trials, and the like. By specifying the maximum number of trials, a user may limit the number of iterations that the re-drilling algorithm 110 completes during the quest for the optimal trajectory. By way of illustration using FIG. 7, the maximum number of trials is 10,000 and the tension safety factor is 1.25. With these settings, the re-drilling algorithm 110 will only complete 10,000 iterations in an effort to find an optimal trajectory and will flag any trajectories that do not satisfy a tension safety constraint of 1.25 with an error

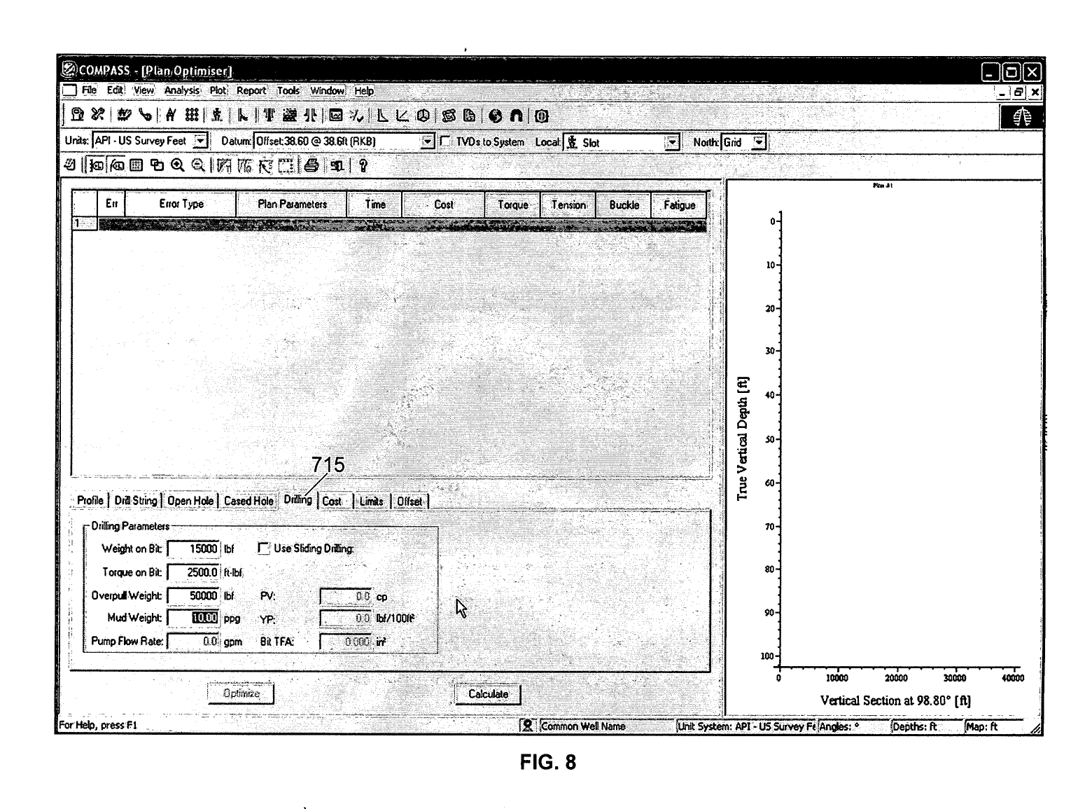

A user may specify mechanical and operational criteria that will be used in the re-drilling algorithm 110 using tabs 710-735. Using the cost tab 710, a user may enter costs associated with the drilling operation. These costs will be used in determining the cost of each individual plan calculated. With the drilling tab 715, a user may specify anticipated or required drilling parameters, such as weight on the bit, torque at the bit, overpull weight, mud weight, pump flow rate, a slide drilling option, and the like (see FIG. 8).

Other criteria that a user may specify include the drill string, open hole, and cased-hole parameters. The drill string tab 730 allows identification of the components that form the drill string (e.g., 4½ 20.00# S NC50 (IF)) along with the associated length (e.g., 10000.00). Using the open-hole tab 725, a user may specify the vertical depth of the open hole, or leave it as zero to use the total depth, of the redrill plan, hole diameter, tortuosity, friction factor, and maximum angle in the open hole sections allowed for any generated redrill plan. Similarly, a user may specify the following parameters using the cased-hole tab 720: Vertical Depth of Casing present in plans to be computed, Casing Internal Diameter (ID), Friction Factor for the Casing, Tortuosity, and the max angle in cased hole for the proposed plans (i.e. no plans will be generated that exceed this inclination).

Tab 610 allows specification of the minimum kick off depth, maximum kick off depth, and step size for each offset. By specifying the minimum kick off depth, a user may indicate the depth within the previously drilled well at which the branch (i.e., offset) should begin. Conversely, a user may limit the maximum kick off depth for each offset using tab 610. Using the step size criterion, a user may designate the frequency of iterations. For example, the algorithm 110 may only plan trajectories from 1100 feet to 5000 feet. If the step size is 100, the algorithm 110 plans these trajectories from that particular offset well starting at depths of 1100 feet, 1200 feet, 1300 feet, and so on.

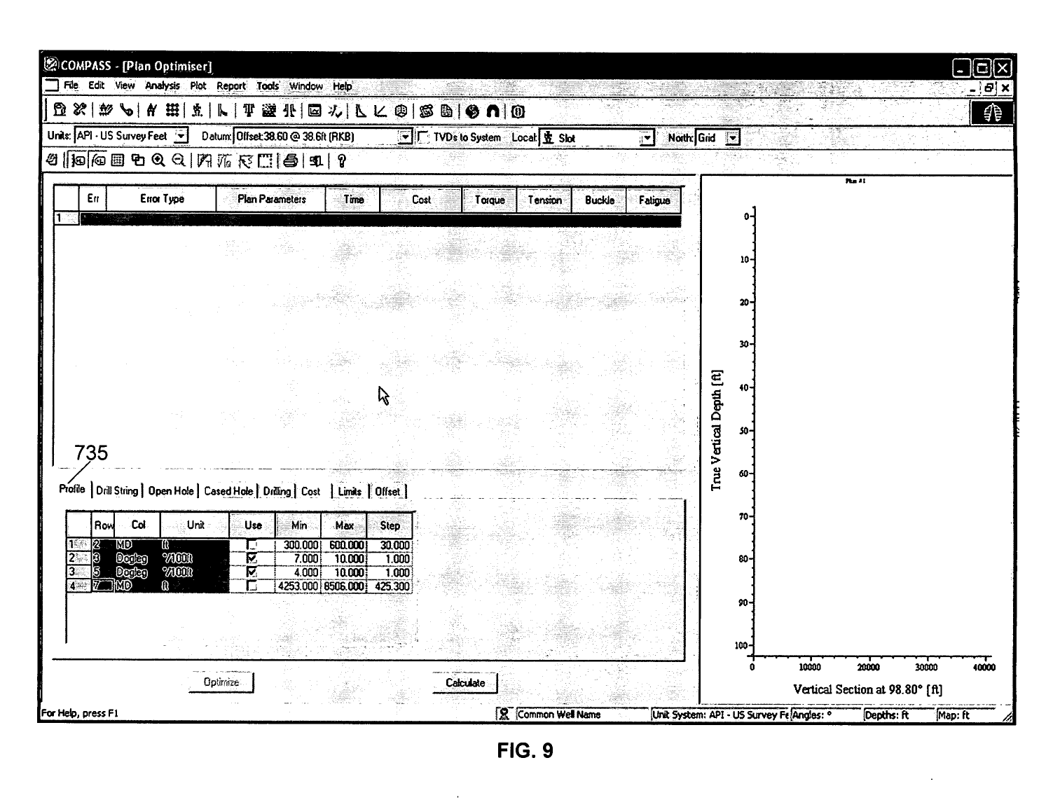

The profile tab 735 enables specification of additional re-drill criteria, which is most clearly seen in FIG. 9. It is within this tab that a dogleg constraint(s) can be applied as design criteria for offset redrill plans. This will allow the redrill algorithm to iterate only through acceptable curvature (i.e. dogleg) ranges for each offset redrill that it plans. Once skilled in the art will appreciate that dogleg may be characterized by the following conventional formula: Dogleg(β)=cos⁻¹(sin i₁) sin(i₂) cos(α₁−α₂)+cos(i₁) cos(i₂) where i₁ is the inclination of the first station, α₁ is the azimuth angle of the first station, i₂ is the inclination of the second station, α₂ is the azimuth angle of the second station. A station is a survey point. For example, when there are points at a measured depth 100 feet, 200 feet, 300 feet, there are 3 stations, or survey points.

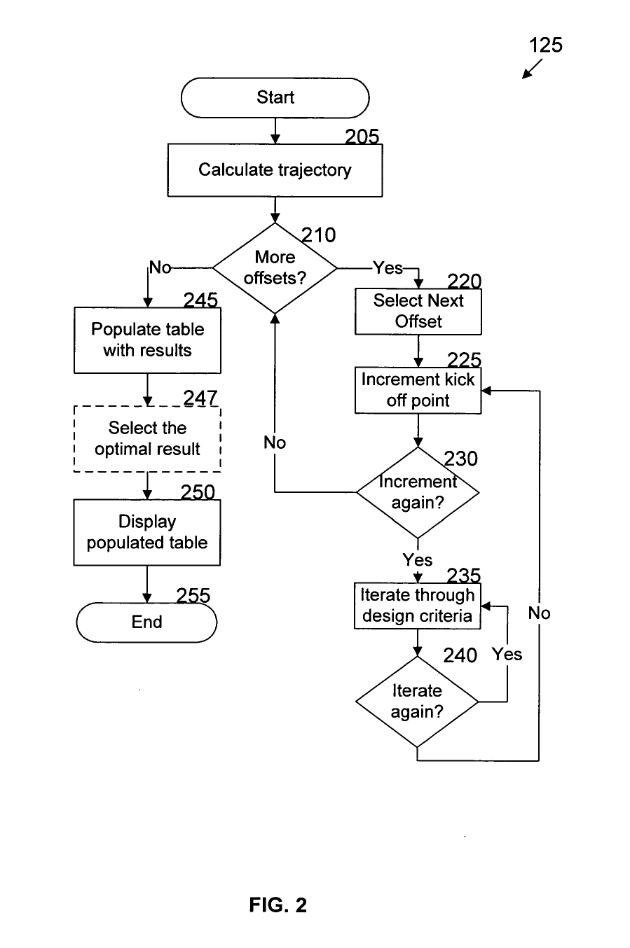

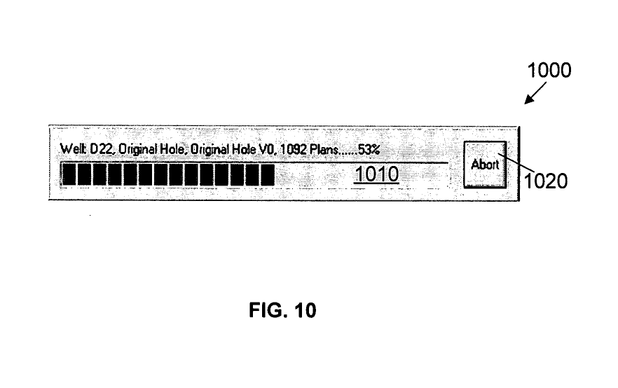

Returning to FIG. 1B, step 120 is followed by step 125. In step 125, the re-drilling algorithm 110 runs the optimization subroutine. This subroutine is described in greater detail with reference to FIG. 2. While the re-drilling algorithm 110 completes this subroutine, it creates a pop-up window 1000 with a dynamic indicator 1010 (see FIG. 10). This dynamic indicator provides both a graphical and textual depiction of the completion percentage. For example, the bar 1010 may be a little more than half filled and the text indicates 53%. Armed with this information, a user may decide whether to end the calculation prematurely given the amount of completion. To do this, a user may select the Abort button 1020. If the user selects this button, the re-drilling algorithm 110 selects the optimal re-drill well trajectory only from the trajectories analyzed, which is described in greater detail below.

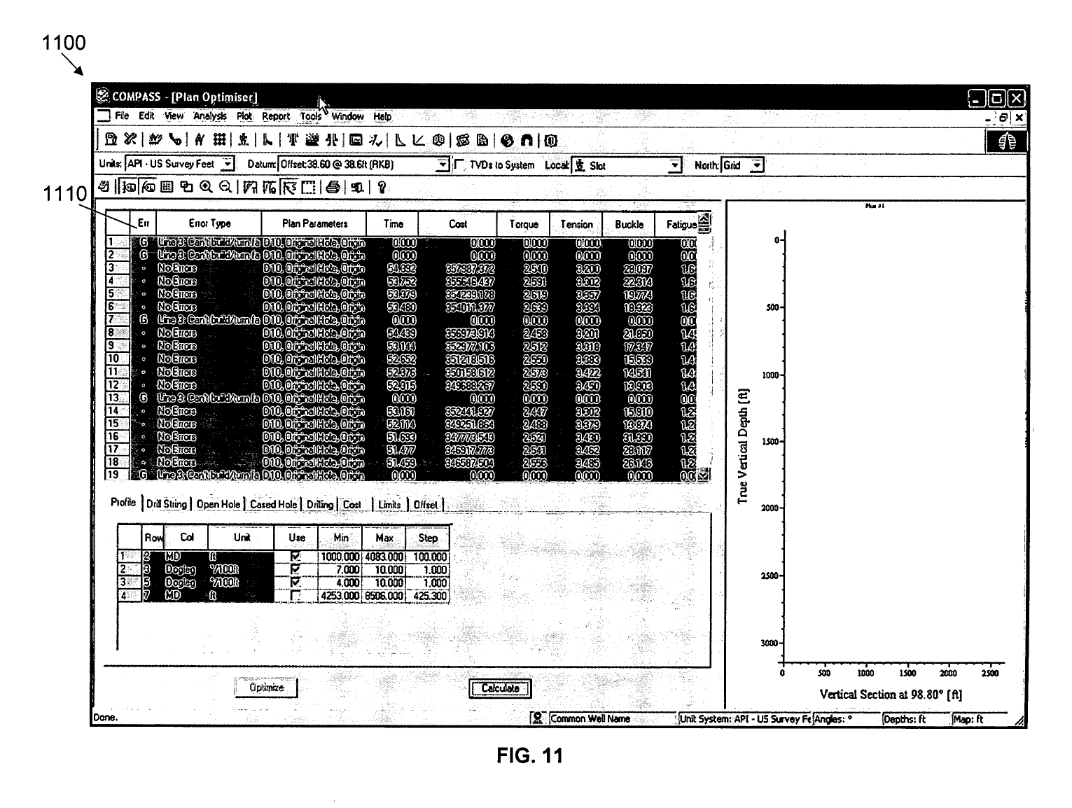

Returning to FIG. 1B, step 125 is followed by step 130. When either the optimization subroutine 125 completes or a user selects the abort button 1020, this subroutine populates a table 1100 with the results (see FIG. 11). The table 1100 may include several columns with headings labeled Err, Error Type, Plan Parameters, Time, Cost, Torque, Tension, and Buckle. This table and corresponding headings are described in greater detail with reference to FIG. 2.

In step 130, the re-drilling algorithm 110 flags any plans that do not meet the design criteria by annotating which criteria failed in the Err (error) column. The user then has the option of removing these plans from the grid by clicking on the entire Err column. Subsequently, only the plans that meet the specified design criteria are displayed. Erroneous plans are plans that do not meet all of the criteria. In an alternative embodiment, this step may involve querying a user on whether erroneous plans should be eliminated.

Step 130 is followed by the decision step 135. In this step the re-drilling algorithm 110 determines whether it should sort the re-drill criteria received in step 120. If the re-drilling algorithm determines that it should sort the re-drill plans based on a specific criteria, the “yes” branch is followed from step 135 to step 140. In step 140, the re-drilling algorithm 110 sorts all the re-drill plans by the criteria specified in the sort request.

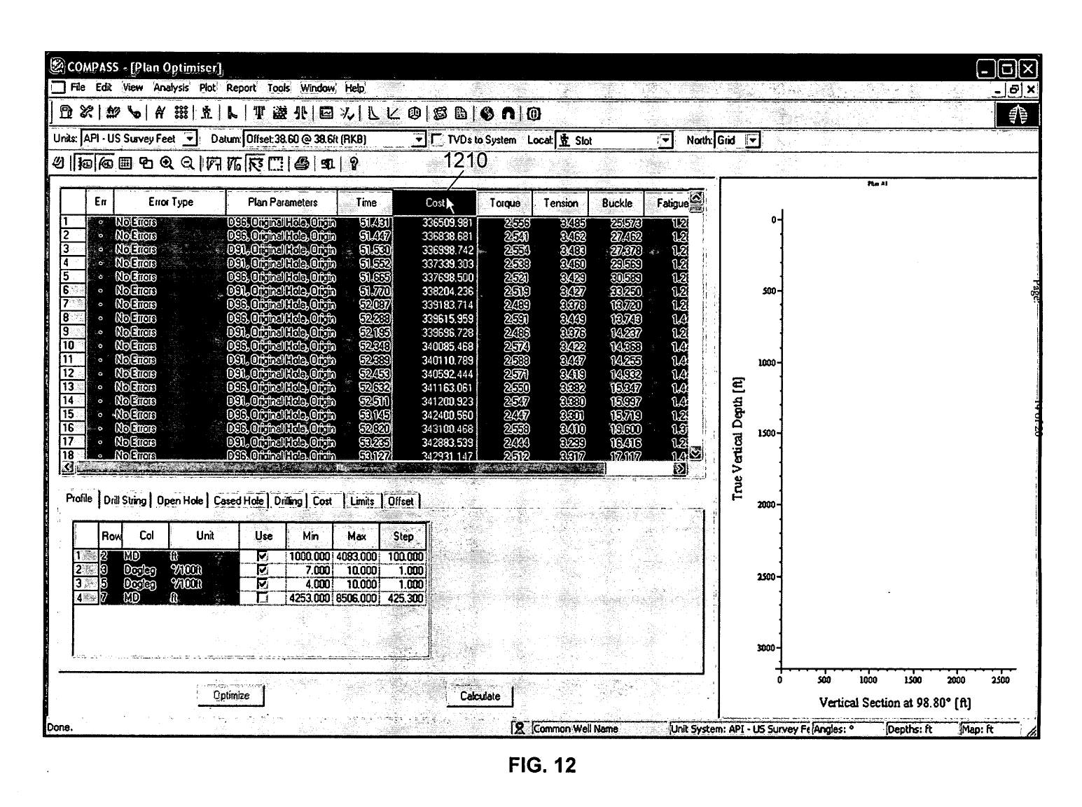

Turning now to FIG. 12, this figure illustrates how the re-drilling algorithm 110 responds to a sort request. For example, a user may click on the cost table heading 1210 to sort all of the trajectories by cost. Selecting this table heading highlights the entire cost column and arranges the trajectories in an ascending sort. Alternatively, a user may sort by time, torque, tension, buckle, and fatigue. By including the sort feature, the re-drilling algorithm 110 may visually present potential re-drill trajectories to a user in a manner that enables efficient identification of the optimal re-drill trajectory.

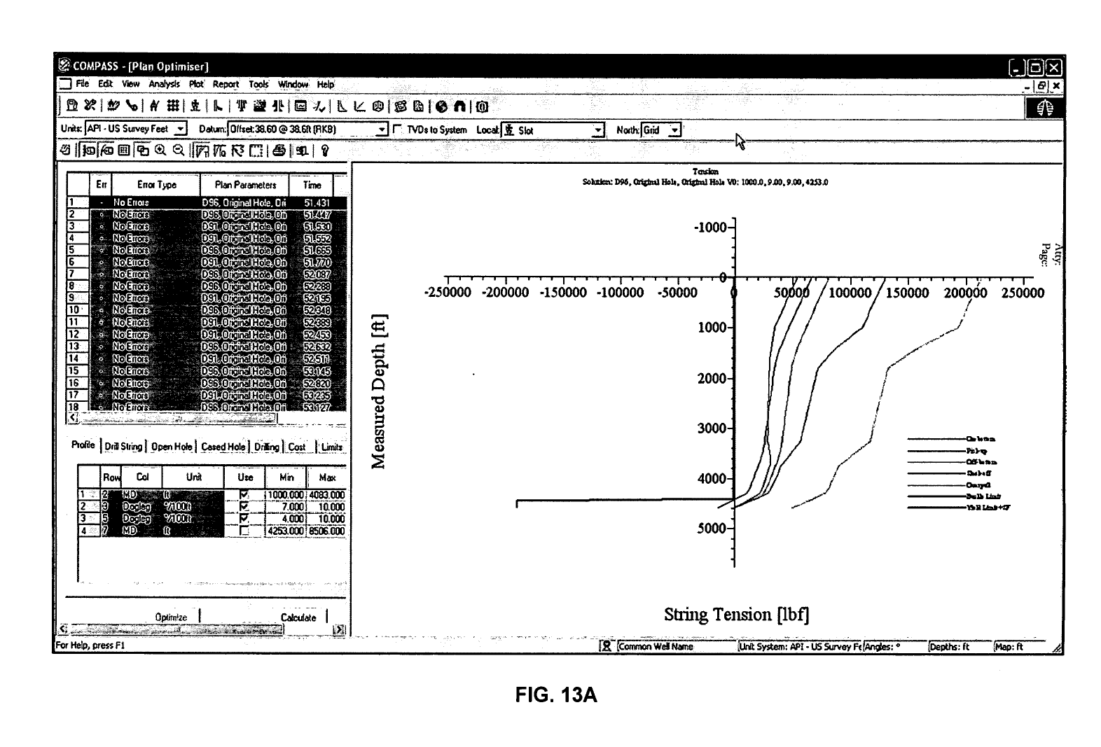

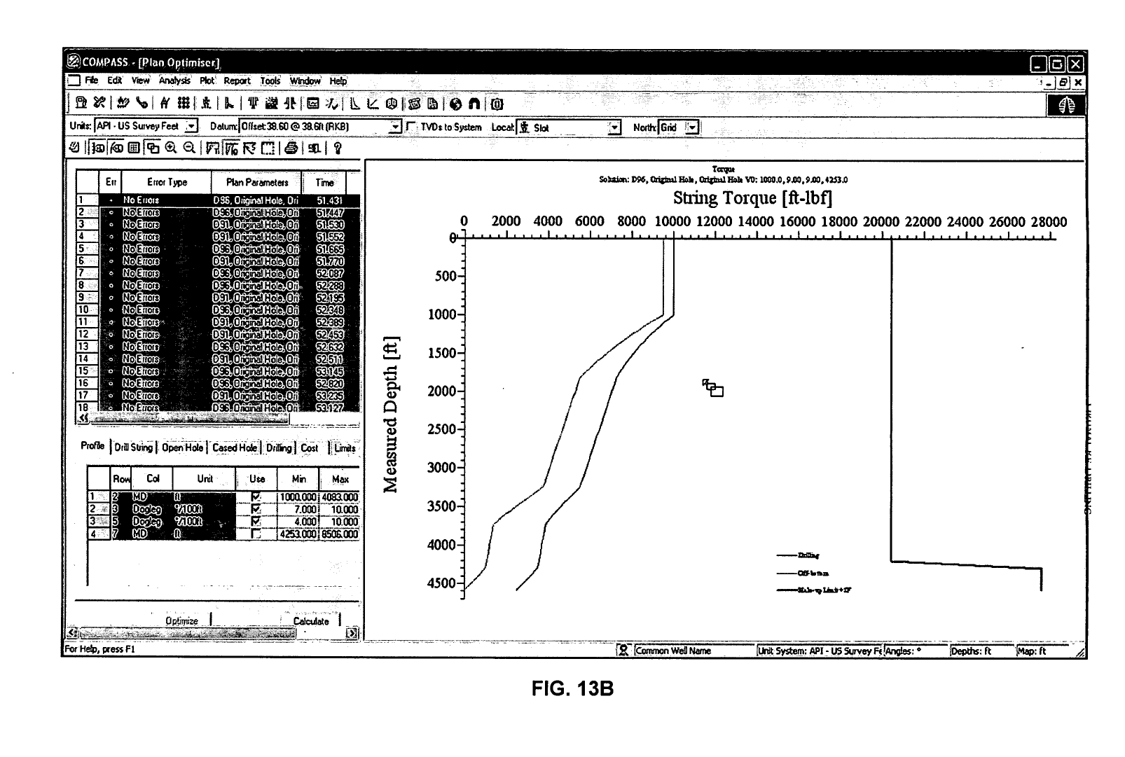

In an alternative embodiment, the re-drilling algorithm 110 may include a step after step 135 that determines whether a user requested that the re-drilling algorithm 110 display associated plots, which is more clearly indicated in FIG. 13A. By viewing these plots, a user may identify engineering parameters associated with the plans, such as tension plots and side force plots In addition to the string tension plot shown in FIG. 13A, a user may view the string torque plot shown in FIG. 13B for D96. In FIG. 13C, a user may view the manner that the true vertical depth varies with a given vertical section for D96.

Returning to FIG. 1B, step 140 is followed by step 145. In step 145, the re-drilling algorithm 110 receives a user-selected optimal re-drilling trajectory. Before receiving this trajectory, the re-drilling algorithm 110 may wait on additional input from the user. Alternatively, the re-drilling algorithm 110 may query the user on whether the user is ready to select the optimal re-drilling trajectory. In an alternative embodiment, a user may select more than one plan. In another alternative embodiment, the algorithm 110 may select the optimal re-drilling trajectory.

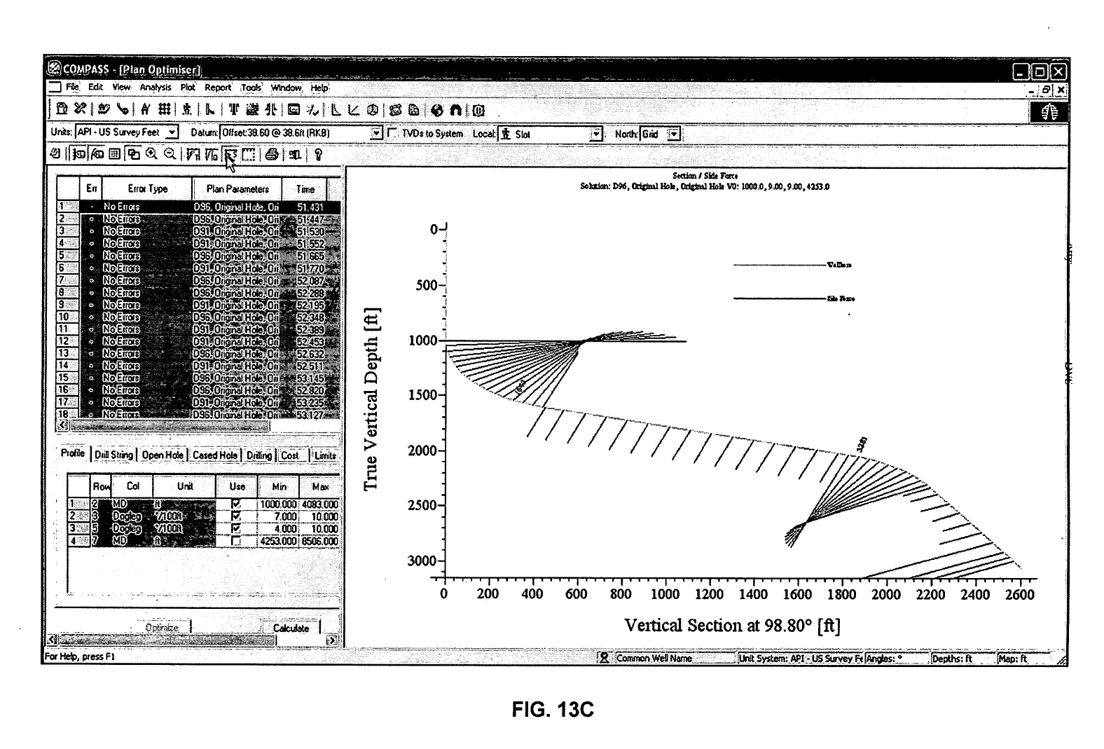

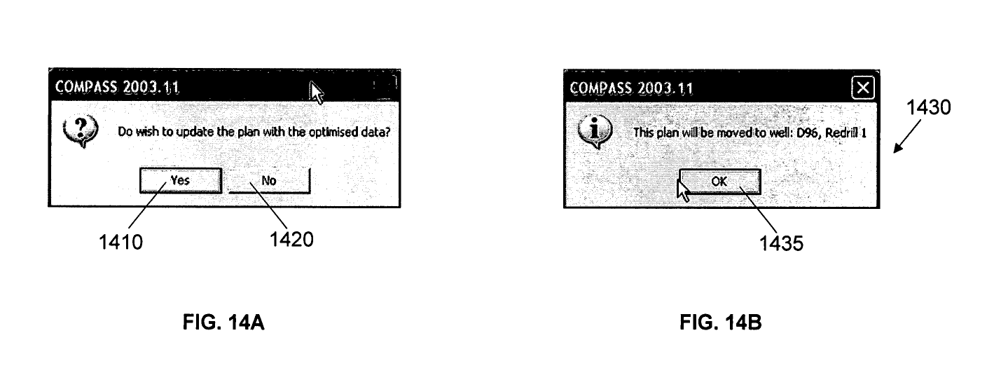

Step 145 is followed by the decision step 150. In step 150, the re-drilling algorithm 110 determines whether it should associate the optimized re-drill trajectory with the currently selected offset well. Usually this step is completed after receiving some user acknowledgement, which is more clearly seen in FIGS. 14A-14B. In FIG. 14A, the re-drilling algorithm 110 queries the user on whether the currently selected redrill plan should be updated with the optimized data. The optimized data refers to the data associated with the optimal re-drilling trajectory the user-selected in step 145. If the user selects the “yes” box 1410, the re-drilling algorithm 110 follows the “yes” branch from step 150 to step 155 (see FIG. 1B). In step 155, the re-drilling algorithm 110 associates the re-drill plan with the corresponding offset well. Though shown as a single step, step 155 may be a subroutine consisting of a series of steps, such as notifying the user where the optimized data may be found and awaiting a response. These are more clearly seen with reference to FIG. 14B. The re-drilling algorithm 110 produces the pop-up window 1430 that identifies where the optimized data will be located. For example, the optimized data will be located under well-bore D96 with the heading “Re-drill 1.” If the user agrees with the movement, the user may select the “OK” box 1435. After receiving this acknowledgement, the re-drilling algorithm 110 automatically associates the optimized data with the offset well without additional user input.

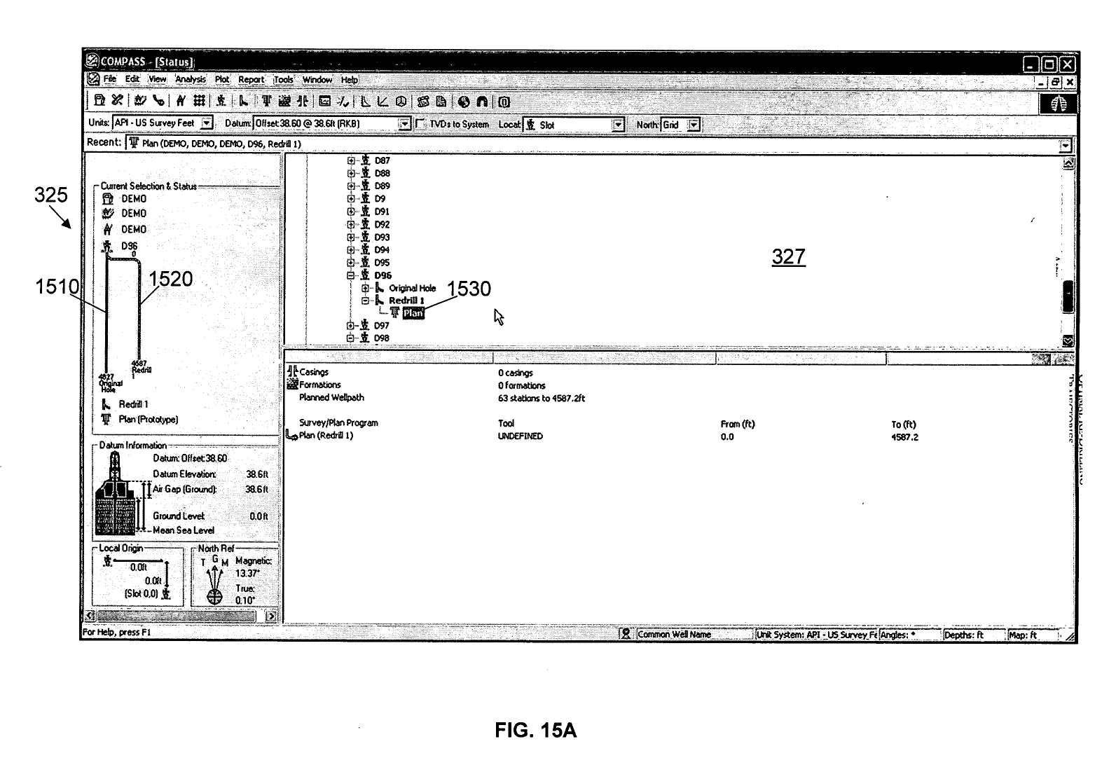

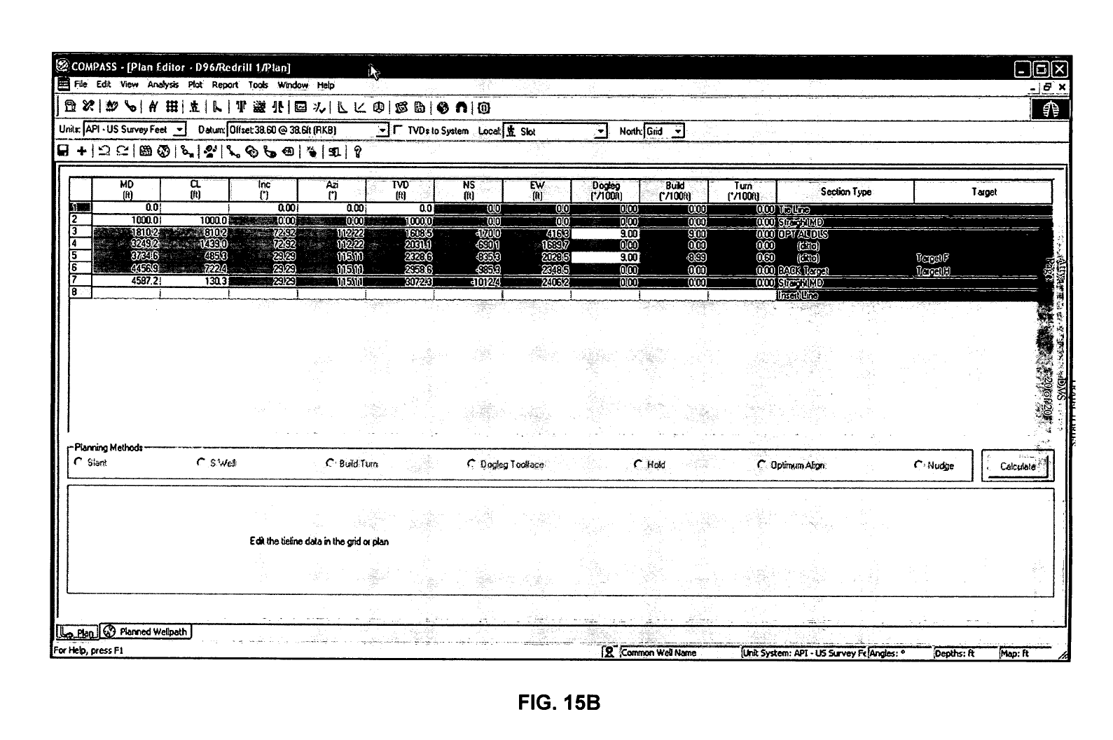

Step 155 may also include making the data associated with the optimal re-drilling trajectory available to the user for viewing, which is more clearly seen in FIG. 15A. In the status window 325, the initial well bore 1510 is shown with the re-drill well bore 1520. The well bore window 327 also displays the re-drill in the well bore D96 hierarchy. By selecting plan 1530, the re-drilling algorithm 110 makes this optimized data available to the user, which is more clearly seen in FIG. 15B. Consequently, a user may access this data using the plan editor feature, which was described with reference to FIG. 4. After the re-drilling algorithm completes step 150, this algorithm ends.

Returning now to FIG. 1B, the algorithm 110 follows the “no” branch from step 150 to step 160 if the optimal re-drill trajectory should not be associated with the offset well. In step 160, the re-drilling algorithm 110 determines whether to attempt optimization again. This decision may be based on a predefined number or user-selected number. If the algorithm 110 does not optimize again, the “no” branch is followed to the end step 157 and the algorithm 110 ends.

If the algorithm 110 determines that it should attempt to optimize again, the “yes” branch is followed from step 160 to step 165. In step 165, the algorithm 110 determines whether it should use the same intial plan during this optimization attempt, which may be based on user input. If the algorithm determines that it should use the same initial plan, the “yes” branch is followed from step 165 to step 113 and the algorithm begins again. Otherwise, the “no” branch is followed from step 165 to step 115. One skilled in the art will appreciate that together step 160 and step 165 facilitate repeating algorithm 110 when desired. For example, the user may want to repeat if the optimizer did not generate any solutions (i.e. all had errors). In that case, a user may alter a parameter before the algorithm 110 is repeated. In addition, if the “optimize” button is selected (see FIG. 14A), the “best” candidate from each offset based on the optimized parameter set in the Limits tab (i.e., cost, anti-collision, torque/drag) is selected instead of generating multiple candidates for each offset. In an alternative embodiment, steps 150, 160, and 165 may be eliminated such that the algorithm 110 always associates the data because step 155 will always be completed.

Turning now to FIG. 2, this figure is a flow chart of the optimization subroutine 125 described with reference to FIG. 1B. One skilled in the art will appreciate that the optimization subroutine 125 is completely automatic and does not depend on any user-input. Hence, it is a truly automated method of identifying the optimized re-drilling trajectory.

The optimization subroutine begins at step 205. In step 205, this subroutine starts with a previously computed trajectory in light of the preliminary trajectory design parameters The calculation determines the following output parameters: cost, time, torque, tension, buckle, and fatigue for the initial planned trajectory. Optimization criteria must be selected. For example, a user may select anti-collision as the optimization criteria for generated plans. If the use AC option is checked off for each offset in the offset tab, then the redrill algorithm will attempt to optimize generated plans based on error ellipse separation from those offsets. The respective error ellipses around the offsets are used to define the separation between the plan and offset and any plans generated that don't meet the user defined separation criteria are flagged with an error. Other optimization methods include torque/drag and cost.

Step 205 is followed by the decision step 210. In step 210, optimization subroutine 125 determines whether there are additional offsets. As described with reference to FIG. 1B, trajectories are calculated for all the offsets stored in step 117. If there are more offsets, the “yes” branch is followed from step 210 to step 220. In step 220, the optimization subroutine 125 selects the next offset. Step 220 is followed by step 225. In step 225, the optimization subroutine 125 increments the kick-off point, or point at which the offset begins and a branch is formed. As described with reference to FIG. 1B, a user may specify both a minimum and a maximum kick-off point. Though not shown, the step 226 may be skipped for a first iteration, such that a first iteration begins at the minimum kick off depth.

Step 225 is followed by the decision step 230. In this step, the optimization subroutine 220 determines whether the kick off point should be incremented again. This decision may be based upon whether the maximum kick off depth is reached. If the optimization subroutine 125 should not increment again, the “no” branch is followed from step 230 to step 210. Otherwise, the “yes” branch is followed from step 230 to step 235. In step 235, the optimization subroutine 125 iterates through the design criteria. These criteria specify how the trajectory should be designed, the other tabs specify design constraints specific to limits and costs that are not iterated through, but compared to or computed (i.e. costs) with each plan generated to see if any of these constraints are exceeded. In essence, this step involves varying each design criteria while noting the appropriate output parameters. Step 235 is followed by the decision step 240. In step 240, the optimization subroutine 125 determines whether it should iterate again, based on whether all of the design criteria have been properly varied. To iterate again, the “yes” branch is followed from step 240 back to step 235. Otherwise the “no” branch is followed from step 240 back to step 225.

If it is determined at step 210 that there are no more offsets, the “no” branch is followed from step 210 to step 245. In step 245, the optimization subroutine 125 produces and populates a table 1100 with the results, or values of the output parameters, which is more clearly seen in FIG. 11. One skilled in the art will note that each of the offsets has a value for the output parameters. For example, row 3 indicates that the time, cost, torque, tension, and buckle parameters are respectively 54.392, 357987.372, 2.540, 3.200, and 28.097. After populating the table 1100 in step 245, the optimization subroutine 125 displays the populated table in step 250, which actually produces the table 1100 that makes the data accessible to a user. In an alternative embodiment (shown as a dashed box) step 247 follows step 245. In step 247, the optimization routine 125 selects the optimum result based on previously specified user constraints. Therefore, this embodiment selects the optimum re-drill plan for the user and only displays that result to the user. The end step 255 follows step 250. As the optimization subroutine 125 ends, the re-drilling algorithm 110 continues at step 130, which is described above with reference to FIG. 1B.

The automated system 100 for identifying an optimal trajectory for re-drilling to reach a target using a previously drilled well creates substantial advantages over conventional methods. In addition, the invented system allows viewing of graphical representation of each optimized plan. Therefore, one can view torque, dray, and engineering parameters. Since the current system is automated, it may efficiently iterate through a host of options in a matter of minutes. The considerable time savings translates into monetary benefit because a user can quickly rank the re-drill candidates. Moreover, the invented system 100 identifies the optimal trajectory by considering user-specified constraints, which allows a greater degree of customization. A user can select multiple re-drill plans and save all three at one time. For example, a user may find that three plans are close and can save all three. Finally, the system 100 also includes a second level of automation in that it automatically associates the optimal re-drill trajectory with the previously drilled well, without any additional user input. A user may also mandate that only the best redrill plan for every offset be presented in the table as opposed to listing all the generated plans for every offset.

The particular embodiments disclosed above are illustrative only, as the invention may be modified and practiced in different, but equivalent, manners apparent to those skilled in the art having the benefit of the teachings herein. Furthermore, no limitations are intended to the details of construction or design herein shown, other than as described in the claims below. It is therefore evident that the particular embodiments disclosed above may be modified and all such variations are considered within the scope and spirit of the invention. Accordingly, the protection sought herein is set forth in the claims below.

1. An automated method for identifying an optimal well path to reach a target using a previously drilled well, comprising the steps of:
identifying a plurality of well paths associated with the previously drilled well for reaching the target;
automatically identifying a subset of the plurality of well paths that satisfy selected criteria; and
designating at least one of the subset of well paths as the optimal well path.

2. The method of claim 1, further comprising associating the optimal well path with the previously drilled well.

3. The method of claim 2, wherein the step of associating comprises making data for the optimal well path available as a subset of data available for the previously drilled well.

4. The method of claim 2, wherein the step of associating comprises making data for the optimal well path available with a graphic user interface.

5. The method of claim 1, wherein the step of identifying a plurality of well paths comprises processing a plurality of trajectories in a well plan.

6. The method of claim 1, wherein the step of automatically identifying further comprises the steps of:
varying the initial criteria used in the preliminary plan;
computing a subset of well paths that are designed based on the varying criteria;
comparing generated results to user defined constraints;
identifying another subset of well paths that satisfy the user defined criteria; and
repeating the steps of selecting and identifying until an optimal well plan has been selected

7. The method of claim 1, wherein the step of designating further comprises receiving a user selection for the optimal well path and designating the user-selected optimal well path as the optimal well path.

8. The method of claim 1, wherein the step of designating further comprises reviewing the selected criteria, evaluating the subset of well paths that most closely comply with the selected criteria, and designating the most closely compliant well path as the optimal well path.

9. A system for identifying an optimal well path to reach a target using a previously drilled well, the system comprising:
an input device for receiving information from a user;
a server coupled to receive the information from the input device having an automated re-drilling software program, wherein the automated re-drilling software program is for identifying an optimal well path to reach a target using a previously drilled well and comprises the steps of:
identifying a plurality of well paths associated with the previously drilled well for reaching the target;
automatically identifying a subset of the plurality of well paths that satisfy selected criteria; and
designating at least one of the subset of well paths as the optimal well path.

10. The system of claim 9, wherein the input device is selected from the group consisting of a work station, personal computer, and a laptop computer.

11. The system of claim 9, further comprising a plurality of input devices, wherein the server may simultaneously determine an optimal well path for all of the plurality of input devices.

12. The system of claim 9, wherein the server further comprises drilling software for receiving the optimal well path from the automated re-drilling software program.

13. The system of claim 12, wherein the automated re-drilling software program is integrated into the drilling software.

14. The system of claim 9, wherein the selected criteria are selected from the group consisting of dogleg constraints, limit constraints, offset constraints, drilling parameter constraints, and depth constraints.

15. A computer readable medium encoded for identifying an optimal trajectory to reach a target using a previously drilled well having instructions comprising the steps of:
identifying a plurality of well paths associated with the previously drilled well for reaching the target;
automatically identifying a subset of the plurality of well paths that satisfy selected criteria; and
designating at least one of the subset of well paths as the optimal well path.

16. The computer readable medium of claim 15, wherein the computer readable medium is integrated with drilling software.
varying the initial criteria used in the preliminary plan;
computing a subset of well paths that are designed based on the varying criteria;
comparing generated results to user defined constraints;
identifying another subset of well paths that satisfy the user defined criteria; and
repeating the steps of selecting and identifying until an optimal well plan has been selected

17. The computer readable medium of claim 15, wherein the step of automatically identifying further comprises the step of:
varying a first user-selected criteria,
identifying a first subset of well paths that satisfy the first user-selected criteria,
selecting one of the remaining user-selected criteria;
identifying another subset of well paths that satisfies the currently selected criteria; and
repeating the steps of selecting and identifying until all the remaining user-selected criteria have been selected.

18. The computer readable medium of claim 15, wherein the step of designating further comprises reviewing the selected criteria, evaluating the subset of well paths that most closely comply with the selected criteria, and designating the most closely compliant well path as the optimal well path.

19. The computer readable medium of claim 15, further comprising the step of associating the optimal well path with the previously drilled well, wherein the step of associating comprises making data for the optimal well path available as a subset of data available for the previously drilled well.

20. The computer readable medium of claim 15, wherein the step of identifying a plurality of well paths comprises processing a plurality of trajectories in a well plan.
